(19) United States
(12) Patent Application Publication
(10) Pub. No.: US 2009/0287764 A1
(43) Pub. Date: Nov. 19, 2009

(54) MEDIA ACCESS CONTROL SERVER FOR RADIO ACCESS NETWORK

(75) Inventors: Rajesh S. Pazhyannur, Lake Zurich, IL (US); Karthikeyan Arumugam, Palatine, IL (US); Dhaval V. Patel, Schaumburg, IL (US); Joseph M. Pedziwiatr, La Grange, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/120,683

(22) Filed: May 15, 2008

(51) Int. Cl. G06F 15/16; H04L 9/32

(52) U.S. Cl. 709/203; 726/4

(57) ABSTRACT

A method (200, 300, 400) and a system (100, 500) of controlling access to media content (120). A first setup request indicating a request to access at least a first portion of the media content can be received from a mobile client (104). A first authorization request can be communicated to a policy manager (116, 132) to inquire whether access by the mobile client to the first portion of the media content is authorized, and a first authorization response to the first authorization request can be received from the policy manager. When the first authorization response indicates that the request to access the first portion of the media content is authorized, a second authorization response that indicates that the request to access the first portion of the media content is authorized can be communicated to the mobile client.

### BACKGROUND OF THE INVENTION

1. Field of the Invention

The present invention generally relates to mobile communications and, more particularly, to delivery of media content to mobile clients.

2. Background of the Invention

The popularity of on-demand video services accessible via the Internet has grown tremendously in recent years. This growth has generally tracked increases in bandwidth that have become available to consumers via wired Internet connections (e.g. digital subscriber lines and broadband cable connections). Nonetheless, consumers are now demanding access to on-demand video services via radio access networks so that these services can be accessed using mobile devices, such as personal digital assistants, mobile telephones and the like. The amount of bandwidth available via radio access networks is typically more limited than the bandwidth available via wired Internet connections, however. If consumers were allowed to randomly access as much video content as they desire, the radio access networks could quickly become congested. In consequence, consumers would suffer high latencies and reduced data communication rates.

### SUMMARY OF THE INVENTION

The present invention relates to a method of controlling access to media content. The method can include receiving from a mobile client a first setup request indicating a request to access at least a first portion of the media content, communicating a first authorization request to a policy manager to inquire whether access by the mobile client to the first portion of the media content is authorized, and receiving from the policy manager a first authorization response to the first authorization request. Further, when the first authorization response indicates that the request to access the first portion of the media content is authorized, a second authorization response that indicates that the request to access the first portion of the media content is authorized can be communicated to the mobile client.

The present invention also relates to a system that controls access to media content. The system can include a media access control server that receives from a mobile client a first setup request indicating a request to access at least a first portion of the media content, communicates a first authorization request to a policy manager to inquire whether access by the mobile client to the first portion of the media content is authorized, and receives from the policy manager a first authorization response to the first authorization request. Further, when the first authorization response indicates that the request to access the first portion of the media content is authorized, the media access control server can communicate to the mobile client a second authorization response that indicates that the request to access the first portion of the media content is authorized.

The present invention also relates to a program storage device readable by a machine, tangibly embodying a program of instructions executable by the machine to perform the various steps and/or functions described herein.

### BRIEF DESCRIPTION OF THE DRAWINGS

Preferred embodiments of the present invention will be described below in more detail, with reference to the accompanying drawings, in which:

FIG. 1 depicts a communication system that is useful for understanding the present invention;

FIG. 2 is a signal flow diagram that is useful for understanding the present invention;

FIG. 3 is another signal flow diagram that is useful for understanding the present invention;

FIG. 4 is another signal flow diagram that is useful for understanding the present invention; and

FIG. 5 depicts a block diagram of a system that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

Arrangements described herein relate to controlling access to media content being requested via radio access networks. For example, real time streaming protocol (RTSP) requests that are generated by mobile clients can be routed to a media access control server, and the media access control server can selectively allow access to requested media content based on one or more policies, account settings, or the like. Accordingly, users can be provided varying levels of media content access services, depending on their individual service plans. Moreover, communication parameters applied to communication of the media content to a mobile client can be selectively adjusted based on network conditions, for instance based on an amount of network congestion. Accordingly, the communication parameters used for the exchange of media content can be dynamically adjusted, thereby reducing data communication errors and providing a better user experience.

As used herein, “media content” includes, but is not limited to, audio content, video content and/or text content. In that regard, the media content can be streamed to or from one or more client devices using a suitable streaming protocol. Examples of such protocols include, but are not limited to, RTSP, User Datagram Protocol (UDP), unicast, multicast, IP multicast and peer-to-peer (P2P).

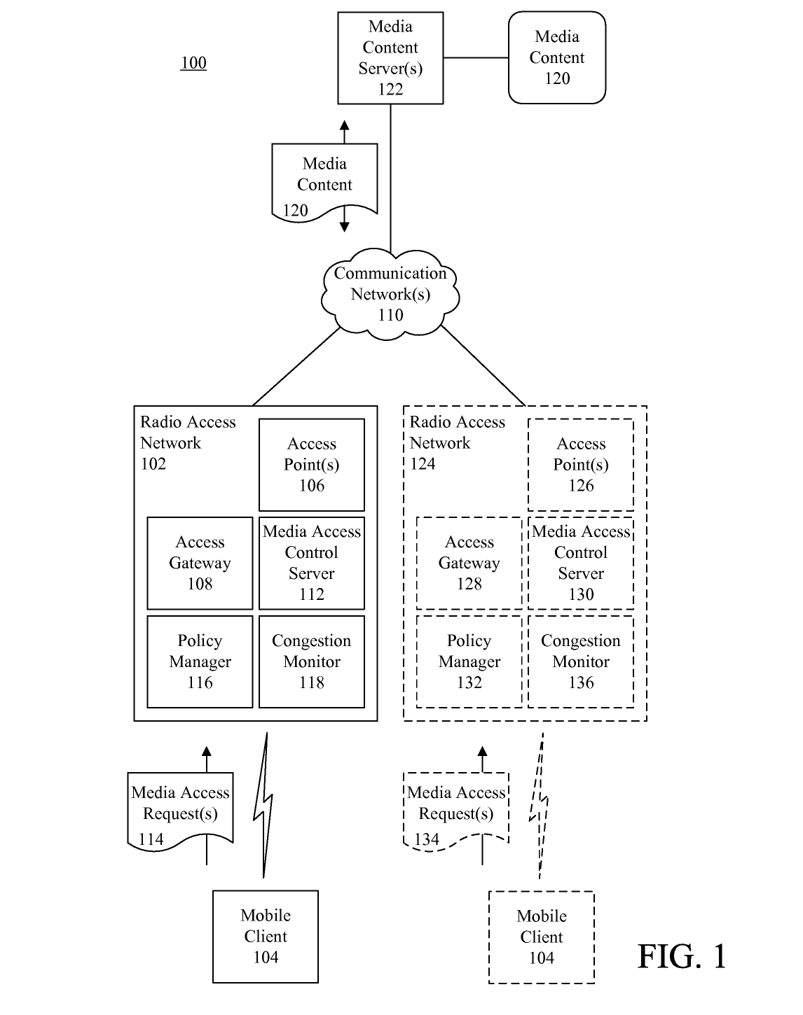

FIG. 1 depicts a communication system 100 that is useful for understanding the present invention. The communication system 100 can include one or more radio access networks 102, 124 and at least one mobile client 104 that may wirelessly communicate via the radio access networks 102, 124. The mobile client 104 can be, for instance, a mobile station (e.g. a mobile telephone, a mobile radio, a mobile computer, a personal digital assistant, or the like), a computer, a set top box, an access terminal, a subscriber station, a network appliance, user equipment, or any other device suitably configured to communicate via the radio access network 102. As such, the mobile client 104 can comprise a processor/controller, a data storage device, a user interface, a communication adapter (e.g. a transceiver, network adapter, etc.), and/or other suitable components.

The radio access network 102 may comprise, an interconnect communications network (e.g. a cellular communications network), a dispatch communications network, a metropolitan area network (MAN), a WiFi network, a Mesh network, a wireless local area network (WLAN) and/or any other networks or systems that support wireless communications. Moreover, the radio access network 102 can be configured to communicate data via IEEE 802 wireless communications, for example, 802.11 and 802.16 (WiMAX), 3G, 4G, EUTRAN, UMB, WPA, WPA2, GSM, TDMA, CDMA, WCDMA, OFDM, direct wireless communication, or any other communications format. Indeed, the radio access network 102 can be implemented in accordance with any suitable communications standards, protocols, and/or architectures, or a suitable combination of such standards, protocols, and/or architectures.

At least one access point 106 can be provided for the radio access network 102. The access point 106 can be, for example, a base transceiver station, a repeater, a WLAN access point, or any other system comprising equipment for wirelessly communicating with the mobile client 104. As such, the access point 106 can comprise one or more antenna elements and one or more components for transmitting and receiving RF signals (e.g. a transceiver). As known to the skilled artisan, the access point 106 also may include any of a myriad of other suitable components, for instance a network adapter, a communication port, a controller, and so on, but the invention is not limited in this regard.

The radio access network 102 also can include an access gateway 108 that routes communication signals exchanged with systems outside the radio access network 102. For instance, the access gateway 108 can communicatively link the radio access network 102 to one or more external communication networks 110. Examples of such communication networks can include, but are not limited to, a wide area network (WAN), such as the Internet or the World Wide Web, a public switched telephone network (PSTN), a local area network (LAN), or the like. Access gateways are also known to the skilled artisan.

The radio access network 102 also can include a media access control server 112 that processes media access requests 114 generated by the mobile client 104 in order to control access to requested media content. Such media access requests 114 can, for example, request authorization to upload media content from the mobile client 104 or download media content to the mobile client 104.

In one arrangement, the mobile client 104 can address the media access requests 114 directly to the media access control server 112. In another arrangement, the radio access network 102 can automatically route any media access requests 114 generated by the mobile client 104 directly to a suitable media access controller, such as the media access control server 112, regardless of the target addresses identified within the media access requests 114. For instance, a controller within the access gateway 108 can identify the media access request 114 as an RTSP request, and immediately forward such media access request 114 to the media access control server 112.

The media access control server 112 can implement media access control in accordance with various media access policies. For example, the media access control server 112 can communicate with a policy manager 116 to retrieve information relevant to media access policies to be implemented, as will be discussed herein, and determine whether the mobile client 104, or a user of the mobile client 104, is authorized to access (e.g. upload or download) the requested media content 120 via the radio access network 102. If the mobile client 104 or the user of the mobile client is authorized to access the requested media content 120, the media access control server 112 can coordinate with one or more media content server(s) 122 that host media content 120 to selectively deliver or receive the requested media content 120 to/from the mobile client 104.

A media content server 122 can be a network server, a Web server, or any other device or system suitable for hosting media content 120 that may be accessed via the radio access network 102 and/or receive media content 120 via the radio access network. The media content servers 122 can store/retrieve the media content 120 from any suitable data storage mediums, as is known to those skilled in the art. In one arrangement, the radio access network 102 can be communicatively linked to one or more media content servers 122 via the communication network 110, or another suitable communication network(s). In another arrangement, the media content servers 122 can be contained within the radio access network 102.

Further, the media access control server 112 and/or the policy manager 116 can provision the access gateway 108 to allow the media content to be communicated between the mobile client 104 and the media content server 122 in accordance with a particular level quality of service (QoS), for instance a QoS indicated by the media content server 122. For example, the media access control server 112 and/or the policy manager 116 can receive QoS indicators from the media content server 122 and communicate corresponding configuration parameters to the access gateway 108. The media access control server 112 and/or the policy manager 116 also can reserve network resources, such as bandwidth and processing resources on the access point 106, for communication of the media content 120. Accordingly, the media content 120 can be delivered in accordance with a desired communication configuration.

The functionality of the media access control server 112 and the policy manager 116 both can be implemented in a single processing system, or implemented among two or more processing systems. If the media access control server 112 and the policy manager 116 are implemented among a plurality of processing systems, such systems can be communicatively linked via the communication network(s) 110 or another communication link.

In an arrangement in which the mobile client 104 may roam among various radio access networks, media access requests 114 generated by the mobile client may be processed by the media access control server 112 of the mobile client's home radio access network 102 or a media access control server associated with the radio access network where the mobile client has established network presence. For example, assume that the mobile client 104 has established network presence on a radio access network 124 that is not its home radio access network 102. Such radio access network 124 also may include access point(s) 126 and an access gateway 128, but may or may not include a respective media access control server 130 and a respective policy manager 132. In an arrangement in which the radio access network 124 does include a media access control server 130, the media access control server 130 can process media access requests 134 generated by the mobile client 104. Moreover, the media access control server 130 can receive policy information for the mobile client 104 from the policy manager 132.

Alternatively, the media access control server 130 can receive policy information for the mobile client 104 from the policy manager 116 of the mobile client's home radio access network 102. Such policy manager 116 can be identified by the radio access network 124 in any suitable manner. For instance, the home radio access network 102 and/or the policy manager 116 can be identified to the radio access network 124 during call setup for the mobile client 104, or identified within a header, body or footer of the media access requests 134.

In yet another arrangement, the mobile client 104 can address the media access requests 134 to the media access control server 112 of the mobile client's home radio access network 102, or the media access request 134 can be forwarded to the media access control server 112 by the radio access network 124. Communication of the media access request 134 to the media access control server 112 can be implemented regardless of whether the radio access network 124 includes the media access control server 130 and/or the policy manager 132.

The radio access network 102 also can include a congestion monitor 118. Similarly, the radio access network can comprise a congestion monitor 136. The congestion monitors 118, 136 can monitor network congestion on the respective radio access networks 102, 124 and provide congestion notifications to the respective media access control servers 112, 130 when their respective radio access networks 102, 124 reach a threshold level of congestion. Such threshold level of congestion can be determined, for example, by the total amount of bandwidth being consumed within the radio access network 102, the amount of data being propagated through a radio access network 102 for a particular period, detected latencies for signals propagated via the radio access network 102, and so on. In one arrangement, the congestion monitors 118, 136 can be located at the respective access points 106, 126 at the respective access gateways 108, 128, and/or elsewhere within the radio access networks 102, 124.

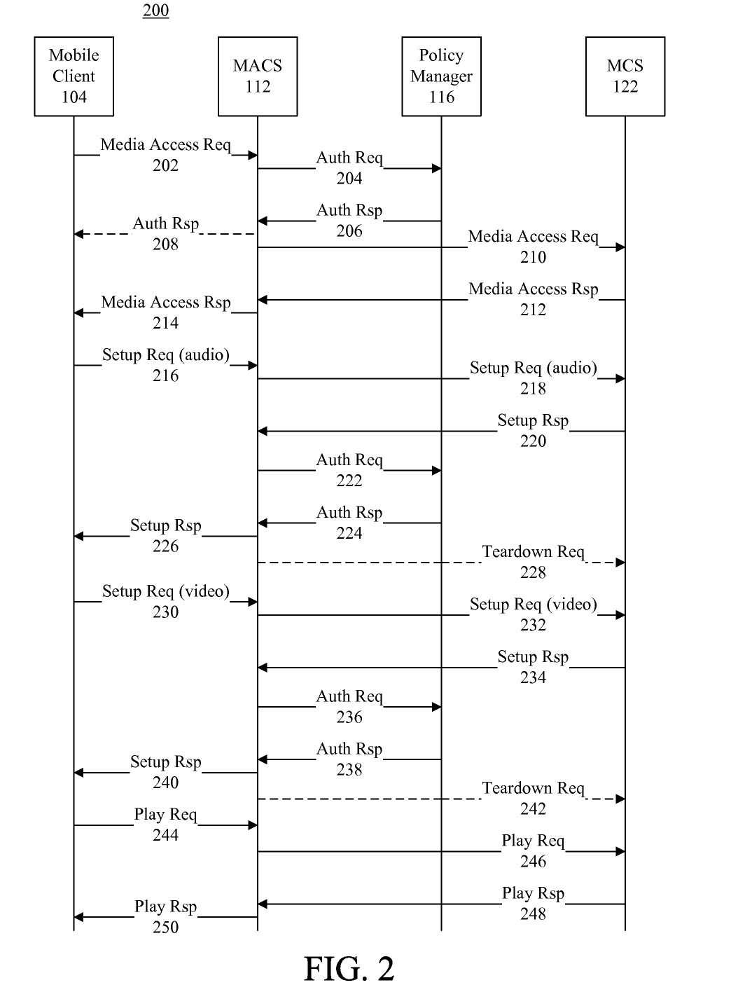

Referring to FIG. 2, a signal flow diagram is depicted which presents a method 200 of controlling access to media content that is useful for understanding the present invention. At step 202, the mobile client 104 can communicate to the media access control server 112 a media access request identifying media content to be accessed (e.g. uploaded or downloaded) and the media content server 122 to/from which the media content is to be accessed. The media access request also can identify a user and/or user account for whom the media access request is being generated. The media access request can be, for example, an RTSP Describe request.

At step 204, the media access control server 112 can communicate an authorization request to the policy manager 116 inquiring whether the mobile client 104, or a user or user account for whom the media access request 202 was generated, is authorized to access the requested media content via the radio access network. At step 206 the policy manager 116 can communicate an authorization response to the media access control server 112 indicating whether the requested media content access is authorized. At step 208 the media access control server 112 can communicate a corresponding authorization response to the mobile client 104.

The authorization request can be denied if the user/user account is not authorized to access media content via the radio access network, or if the user/user account has reached a threshold for an amount of media content that may be accessed for a given period. Otherwise, the authorization request can be approved. If the authorization response indicates that the media access request has been denied, the process can end. If, however, the authorization response indicates that the media access request has been approved, the process can continue to step 210. At this point it should be noted that steps 204-208 are optional, and need not be implemented.

At step 210, a media access request can be communicated from the media access control server 112 to the media content server 122. Such media access request also can be an RTSP Describe request. At step 212 the media content server 122 can communicate a media access response to the media access control server 112 indicating whether media content being requested for download is available and/or whether the media content server 122 is ready to receive an upload of media content. The media access response also can provide other details about media content to be downloaded, or applicable upload/download parameters. By way of example, the media access response can be an RTSP OK response. At step 214, a corresponding media access response can be communicated from the media access control server 112 to the mobile client 104.

At step 216, the mobile client 104 can communicate a setup request, for instance an audio setup request, to the media access control server 112. At step 218 the media access control server 112 can communicate a corresponding setup request to the media content server 122. At step 220 the media content server 122 can communicate to the media access control server 112 a setup response indicating that the media content server 122 is ready for upload/download of a first portion of the media content (e.g. the audio portion). The setup response also can indicate the QoS available for communication between the mobile client 104 and the media content server 122, including data flow rates, bit error rates, etc. associated with the transfer of the first portion of the media content.

At step 222 the media access control server 112 can communicate an authorization request to the policy manager 116 requesting authorization to commence upload/download of the first portion of the media content. Such authorization request can include the QoS data received from the media content server 122. Based on account settings associated with the mobile client 104, the policy manager 116 can determine whether the setup request is to be authorized. For instance, the policy manager 116 can determine whether a user of the mobile client 104 has subscribed to an adequate amount of bandwidth and/or has a sufficient amount of data transfer remaining within a particular period (e.g. a billing cycle) to allow for the first portion of the media content to be properly transferred. If so, at step 224 the policy manager 116 can communicate an authorization response to the media access control server 112 authorizing the requested access to the first portion of the media content. Otherwise, the authorization response can deny the authorization request.

If the authorization response indicates that the request to access the first portion of the media content is not authorized, at step 226 a setup response can be communicated from the media access control server 112 to the mobile client 104 to indicate that the setup request is denied. In addition, at step 228 a teardown request can be communicated from the media access control server 112 to the media content server 122 to teardown (e.g. release) the communication links for the present communication session. The process then can terminate.

If, however, the authorization response authorizes access of the first portion of the media content, the setup response communicated from the media access control server 112 to the mobile client 104 at step 226 can correspond to the setup response received by the media access control server 112 at step 220. In addition, the access gateway can be provisioned for the QoS expected for the first portion of the media content, as previously noted, and the process can continue to step 230.

At step 230, the mobile client 104 can communicate another setup request, for instance a video setup request, to the media access control server 112. At step 232 the media access control server 112 can communicate a corresponding setup request to the media content server 122. At step 234 the media content server 122 can communicate to the media access control server 112 a setup response indicating that the media content server 122 is ready for upload/download of a second portion of the media content (e.g. the video portion). The setup response also can include an indicator of the QoS that can be provided for communication between the mobile client 104 and the media content server 122, including data flow rates, bit error rates, etc. associated with the transfer of the second portion of the media content.

At step 236 the media access control server 112 can communicate an authorization request to the policy manager 116 requesting authorization to commence upload/download of the second portion of the media content. Such authorization request can include the indicator of QoS received from the media content server 122 at step 234. Based on account settings associated with the mobile client 104, the policy manager 116 again can determine whether the setup request is to be authorized, as previously described. If the setup request is authorized, at step 238 the policy manager 116 can communicate an authorization response to the media access control server 112 indicating authorization to access (e.g. upload and/or download) the second portion of the media content. Otherwise, the authorization response can deny the authorization request.

If the authorization response indicates that the request to access the second portion of the media content is not authorized, at step 240 a setup response can be communicated from the media access control server 112 to the mobile client 104 to indicate that the setup request is denied. In addition, at step 242 a teardown request can be communicated from the media access control server 112 to the media content server 122 to teardown (e.g. release) the communication links for the present communication session. The process then can terminate.

If, however, the authorization response authorizes access of the second portion of the media content, the setup response communicated from the media access control server 112 to the mobile client 104 at step 240 can correspond to the setup response received by the media access control server 112 at step 234. In addition, the access gateway can be provisioned for the QoS expected for the second portion of the media content, as previously noted, and the process can continue to step 244.

At step 244 the mobile client 104 can communicate a play request (or upload request) to the media access control server 112. For example, the play request can request that the requested media content be streamed from the media content server 122 to the mobile client 104. At step 246 a corresponding play request (or upload request) can be communicated from the media access control server 112 to the media content server 122. The media content server 122 then can communicate a play response 248 (or upload response) indicating that the media content is ready to be streamed (or that the media content server 122 is prepared to receive the upload). At step 250 a corresponding play response (or upload response) can be communicated from the media access control server 112 to the mobile client 104. Upload or download of the first and second portions of the media content then can commence. For example, the streaming of the media content from the media content server 122 to the mobile client 104 can commence.

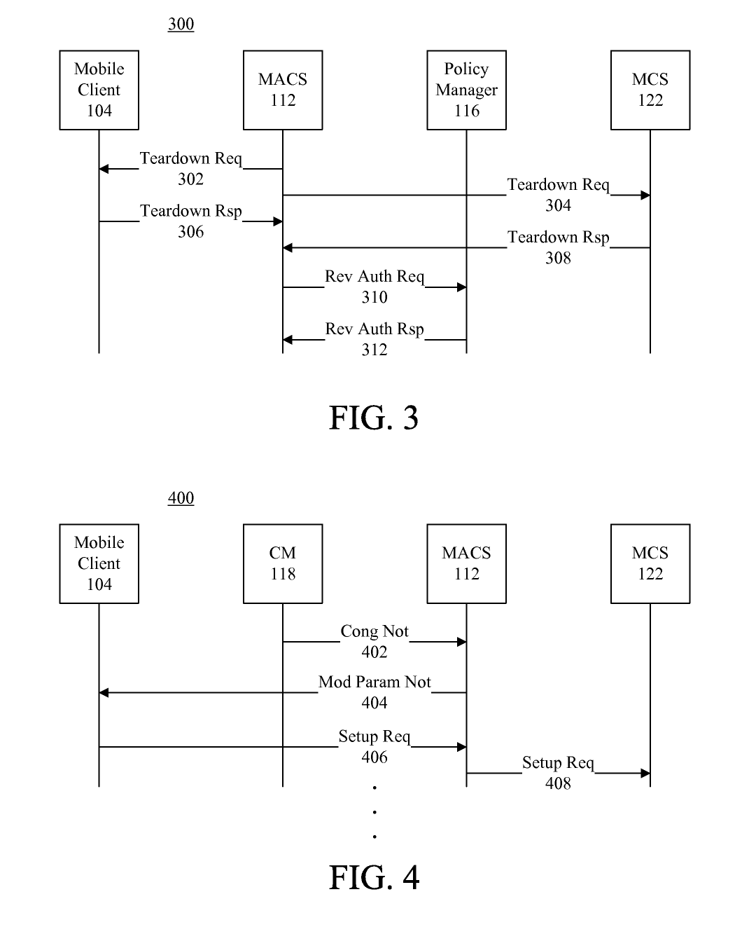

FIG. 3 presents a method 300 of releasing a media transfer session that is useful for understanding the present invention. The method 300 can begin in a state in which the media access control server 112 has determined to initiate teardown of the communication links for the current communication session, for instance if the user of the mobile client 104 is not authorized to access the media content at the indicated QoS, the user has exceeded a threshold limit for the total amount of data to be transferred for a particular subscription, or the like.

At step 302 a teardown request can be communicated from the media access control server 112 to the mobile client 104 to indicate to the mobile client 104 to terminate the communication link with the media content server 122 in the present communication session. At step 304, another teardown request can be communicated from the media access control server 112 to the media content server 122 to indicate to the media content server 122 to terminate the communication link with the mobile client 104 in the present communication session. At step 306, the mobile client 104 can terminate the communication link and a teardown response can be communicated from the mobile client 104 to the media access control server 112 indicating the communication link is terminated. At step 308 the media content server 122 also can terminate the communication link and communicate a teardown response to the media access control server 112 indicating that the communication link is terminated.

At step 310 the media access control server 112 can communicate a revoke authorization request to the policy manager 116 requesting that the authorization for the mobile client 104 to access the media content be revoked. At step 312 the policy manager 116 can communicate a revoke authorization response to the media access control server 112 confirming that the authorization is being revoked. Further, the media access control server 112 and/or the policy manager 116 can provision the access gateway to disable data flows for the requested media content being exchanged between the mobile client 104 and the media content server 122.

FIG. 4 presents a method 400 modifying a media transfer session that is useful for understanding the present invention. The method 400 can begin in a state in which network congestion has been observed in the radio access network, for example by congestion monitor 118.

At step 402, the congestion monitor 118 can communication a congestion notification to the media access control server 112. The media access control server can determine which mobile clients and/or users (e.g. mobile client 104) are affected by the congestion and, at step 404, communicate a modify communication parameters notification to the mobile client 104 to indicate to the mobile client to request a change in communication parameters applied to communication of the media content to/from the mobile client. In one arrangement, the notification can indicate specifically which communication parameters should be modified.

At step 406 the mobile client 104 can communicate a setup request to the media access control server 112 requesting that communication parameters implemented for communicating the media content are modified. In one arrangement, the setup request can indicate new communication parameters with which the media content is to be communicated to/from the mobile client. At step 408, the media access control server 112 can communicate a corresponding setup request to the media content server 122. Such setup request can indicate the new communication parameters. The process can continue as described in FIG. 2 for completing the setup for the mobile client 104 to access the requested media content from the media content server using the modified communication parameters. Notably, the ability to dynamically change communication parameters in this manner can reduce the number of communication errors due to network congestion, thereby providing better user experiences.

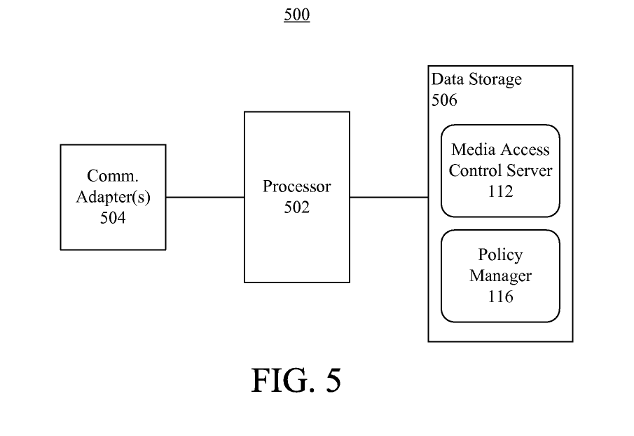

FIG. 5 is a block diagram depicting one example of system 500 that is useful for understanding the present invention. The system 500 can include a processor 502, which may comprise, for example, one or more central processing units (CPUs), one or more digital signal processors (DSPs), one or more application specific integrated circuits (ASICs), one or more programmable logic devices (PLDs), a plurality of discrete components that can cooperate to process data, and/or any other suitable processing device. In an arrangement in which a plurality of such components are provided, the components can be coupled together to perform various processing functions as described herein.

The system 500 also can include, or be coupled to, one or more communication adapters 504. The communication adapters 504 can be any data send/receive device that are suitable for communicating via the access point, communicating via a wired communication network (e.g. via the access gateway), or communicating with other components via a communication bus. Such communication adapters are known to the skilled artisan.

The system 500 further can include data storage 506. The data storage 506 can include one or more storage devices, each of which may include, but is not limited to, a magnetic storage medium, an electronic storage medium, an optical storage medium, a magneto-optical storage medium, and/or any other storage medium suitable for storing digital information. In one arrangement, the data storage 506 can be integrated into the processor 502, though this need not be the case.

A media access control server 112 can be stored on the data storage 506 or otherwise made accessible to the processor 502. The media access control server 112 can be executed by the processor 502 to implement the methods and processes described herein that are performed by the media access control server 112 as described herein. For example, the processor 502 can execute the media access control server 112 to receive media access requests, generate authorization requests, receive authorization responses, forward authorization responses and media access requests, and so on. In addition, the media access control server 112 can communicate with the policy manager 116, as described herein. As noted, the policy manager 116 can be co-located with the media access control server 112, for instance on the data storage 506, but this need not be the case. The media access control server 112 also can be executed to perform any other media access control, and the invention is not limited in this regard.

The signal flow diagrams and block diagrams in the figures illustrate the architecture, functionality, and operation of possible implementations of systems, methods and computer program products according to various embodiments of the present invention. In this regard, each element in the signal flow diagrams or block diagrams may represent a module, segment, or portion of code, which comprises one or more executable instructions for implementing the specified logical function(s). It should also be noted that, in some alternative implementations, the functions noted in the elements may occur out of the order noted in the figures. For example, two elements shown in succession may, in fact, be executed substantially concurrently, or the elements may sometimes be executed in the reverse order, depending upon the functionality involved.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in a program storage device readable by a machine, tangibly embodying a program of instructions executable by the machine to perform methods and processes described herein. The present invention also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a script, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language).

Moreover, as used herein, ordinal terms (e.g. first, second, third, fourth, fifth, sixth, seventh, eighth, ninth, tenth, and so on) distinguish one message, signal, item, object, device, system, apparatus, step, process, or the like from another message, signal, item, object, device, system, apparatus, step, process, or the like. Thus, an ordinal term used herein need not indicate a specific position in an ordinal series. For example, a process identified as a “second process” may occur before a process identified as a “first process.” Further, one or more processes may occur between a first process and a second process.

This invention can be embodied in other forms without departing from the spirit or essential attributes thereof Accordingly, reference should be made to the following claims, rather than to the foregoing specification, as indicating the scope of the invention.

What is claimed is:

1. A method of controlling access to media content, comprising:
receiving from a mobile client a first setup request indicating a request to access at least a first portion of the media content;
communicating a first authorization request to a policy manager to inquire whether access by the mobile client to the first portion of the media content is authorized;
receiving from the policy manager a first authorization response to the first authorization request; and
when the first authorization response indicates that the request to access the first portion of the media content is authorized, communicating to the mobile client second authorization response that indicates that the request to access the first portion of the media content is authorized.

2. The method of claim 1, further comprising:
communicating to a media content server a second setup request corresponding to the first setup request; and
receiving from the media content server a setup response comprising an indicator of a quality of service available for communication of the first portion of the media content.

3. The method of claim 2, wherein communicating the first authorization request to the policy manager comprises:
communicating to the policy manager the indicator of the quality of service available for communication of the first portion of the media content.

4. The method of claim 1, further comprising:
receiving from the mobile client a second setup request indicating a request to access at least a second portion of the media content;
communicating a second authorization request to the policy manager to inquire whether the request to access the second portion of the media content is authorized;
receiving from the policy manager a third authorization response to the second authorization request; and
when the third authorization response indicates that the request to access the second portion of the media content is authorized, communicating a second media access response indicating to the mobile client that the request to access the second portion of the media content is authorized.

5. The method of claim 4, further comprising:
communicating to the media content server a third setup request corresponding to the second setup request; and
receiving from the media content server a setup response comprising an indicator of a quality of service available for communication of the second portion of the media content.

6. The method of claim 5, wherein communicating the second authorization request to the policy manager comprises:
communicating to the policy manager the indicator of the quality of service available for communication of the second portion of the media content.

7. The method of claim 1, further comprising:
in response to receiving a request to release a communication link with a media content server:
communicating a teardown request to the mobile client;
communicating a teardown request to the media content server; and
communicating a revoke authorization request to the policy manager.

8. The method of claim 1, further comprising:
receiving a congestion notification from a congestion monitor within a radio access network indicating that the radio access network is congested;
identifying that the mobile client is affected by the congestion; and
communicating a modify communication parameters notification to the mobile client indicating to the mobile client to request a change in communication parameters applied to communication of the media content to or from the mobile client.

9. The method of claim 8, further comprising:
receiving from the mobile client a second setup request that indicates new communication parameters with which the media content is to be communicated to or from the mobile client; and
communicating to a media content server a third setup request indicating the new communication parameters.

10. A system that controls access to media content, comprising:
a media access control server that:
receives from a mobile client a first setup request indicating a request to access at least a first portion of the media content;
communicates a first authorization request to a policy manager to inquire whether access by the mobile client to the first portion of the media content is authorized;
receives from the policy manager a first authorization response to the first authorization request; and
when the first authorization response indicates that the request to access the first portion of the media content is authorized, communicates to the mobile client a second authorization response that indicates that the request to access the first portion of the media content is authorized.

11. The system of claim 10, wherein the media access control server:
communicates to a media content server a second setup request corresponding to the first setup request; and
receives from the media content server a setup response comprising an indicator of a quality of service available for communication of the first portion of the media content.

12. The system of claim 11, wherein the media access control server communicates to the policy manager the indicator of the quality of service available for communication of the first portion of the media content.

13. The system of claim 10, wherein the media access control server:
receives from the mobile client a second setup request indicating a request to access at least a second portion of the media content;
communicates a second authorization request to the policy manager to inquire whether the request to access the second portion of the media content is authorized;
receives from the policy manager a third authorization response to the second authorization request; and
when the third authorization response indicates that the request to access the second portion of the media content is authorized, communicates a second media access response indicating to the mobile client that the request to access the second portion of the media content is authorized.

14. The system of claim 13, wherein the media access control server:
communicates to the media content server a third setup request corresponding to the second setup request; and
receives from the media content server a setup response comprising an indicator of a quality of service available for communication of the second portion of the media content.

15. The system of claim 14, wherein the media access control server communicates to the policy manager the indicator of the quality of service available for communication of the second portion of the media content.

16. The system of claim 10, wherein:
in response to receiving a request to release a communication link with a media content server, the media access control server communicates a teardown request to the mobile client, communicates a teardown request to the media content server, and communicates a revoke authorization request to the policy manager.

17. The system of claim 10, wherein the media access control server:
receives a congestion notification from a congestion monitor within a radio access network indicating that the radio access network is congested;
identifies that the mobile client is affected by the congestion; and
communicates a modify communication parameters notification to the mobile client indicating to the mobile client to request a change in communication parameters applied to communication of the media content to or from the mobile client.

18. The method of claim 17, wherein the media access control server receives from the mobile client a second setup request that indicates new communication parameters with which the media content is to be communicated to or from the mobile client, and communicates to a media content server a third setup request indicating the new communication parameters.

19. A program storage device readable by a machine, tangibly embodying a program of instructions executable by the machine to perform method steps for controlling access to media content, said method steps comprising:
receiving from a mobile client a first setup request indicating a request to access at least a first portion of the media content;
communicating a first authorization request to a policy manager to inquire whether access by the mobile client to the first portion of the media content is authorized;
receiving from the policy manager a first authorization response to the first authorization request; and
when the first authorization response indicates that the request to access the first portion of the media content is authorized, communicating to the mobile client a second authorization response that indicates that the request to access the first portion of the media content is authorized.

20. The program storage device of claim 19, said method steps further comprising:
communicating to a media content server a second setup request corresponding to the first setup request; and
receiving from the media content server a setup response comprising an indicator of a quality of service available for communication of the first portion of the media content;
wherein communicating the first authorization request to the policy manager comprises communicating to the policy manager the indicator of the quality of service available for communication of the first portion of the media content.
